(19) United States
(12) Patent Application Publication
(10) Pub. No.: US 2018/0252023 A1
(43) Pub. Date: Sep. 6, 2018

(54) METHOD AND DEVICE FOR FILLING A SPACER FRAME FOR PRODUCING AN INSULATION GLAZING

(71) Applicant: SAINT-GOBAIN GLASS FRANCE, Courbevoie (FR)

(72) Inventors: Walter SCHREIBER, AACHEN (DE); Katrin FRANK, AACHEN (DE); Markus STAHL-BIDINGER, HEINSBERG (DE)

(73) Assignee: Saint-Gobain Glass France, Courbevoie (FR)

(21) Appl. No.: 15/741,218

(22) PCT Filed: Sep. 5, 2016
(86) PCT No.: PCT/EP2016/070850

§ 371 Date: May 9, 2018

(30) Foreign Application Priority Data
Sep. 3, 2015 (EP) 15183671.5

(51) Int. Cl. E06B 3/673

(52) U.S. Cl. CPC E06B 3/67317

(57) ABSTRACT

A method and a device for filling a spacer frame with a filler for producing an insulating glazing unit and a spacer frame produced in accordance with the method is disclosed. A fill time of the spacer frame for filling to a fill level of 100% is calculated and the spacer frame is inserted into a filling device with scales and a frame holder. The spacer frame is suspended in suspension devices, the spacer frame is filled for the calculated fill time, and the spacer frame is weighed, and the fill level is determined. If the fill level is larger than 90%, then the filling of the spacer frame is terminated.

The present invention relates to a method and a device for filling a spacer frame for producing an insulating glazing unit and a spacer frame produced in accordance with the method according to the invention.

The thermal conductivity of glass is lower by approx. a factor of 2 to 3 than that of concrete or similar building materials. However, since panes are designed significantly thinner than comparable elements made of brick or concrete, buildings frequently lose the greatest share of heat via external glazing. The increased costs necessary for heating and air-conditioning systems make up a part of the maintenance costs of the building that must not be underestimated. Moreover, as a consequence of more stringent construction regulations, lower carbon dioxide emissions are required. Triple insulating glazing units are an important approach to a solution for this, without which, primarily as a result of increasingly rapidly rising prices of raw materials and more stringent environmental protection constraints, it is no longer possible to imagine the building construction sector. Consequently, triple insulating glazing units constitute an increasingly greater share of outward-directed glazings.

Insulating glazing units usually include two or three panes of glass or polymeric materials that are separated from one another by two individuals spacers. A further pane is placed on a double glazing unit using an additional spacer. During assembly of such a triple glazing unit, very small tolerances specifications apply since the two spacers must be installed at exactly the same height. Thus, compared to double glazing units, the assembly of triple glazing units is significantly more complex since either additional system components must be provided for the assembly of another pane or a time-consuming multiple pass through a conventional system is necessary.

EP 0 852 280 A1 discloses a spacer for double insulating glazing units. The spacer includes a metal foil on the adhesion surface and glass fiber content in the plastic of the main body. Such spacers are also frequently used in triple insulating glazing units, wherein a first spacer is mounted between a first outer pane and the inner pane, and a second spacer is mounted between a second outer pane and the inner pane. Here, the two spacers must be installed congruently to ensure a visually appealing appearance.

WO 2010/115456 A1 discloses a hollow profile spacer with a plurality of hollow chambers for multiple glass panes comprising two outer panes and one or a plurality of middle panes that are installed in a groove-shaped accommodating profile. Here, the spacer can be manufactured both from polymeric materials as well as being made of rigid metals, such as stainless steel or aluminum. The middle glass of the multiple glass panes is preferably fixed in the groove with a primary seal, in particular an adhesive based on butyl, acrylate, or hotmelt. By means of the fixing with the primary seal, an exchange of air between the interpane spaces of the multiple glass pane is prevented.

DE 10 2009 057 156 A1 describes a triple insulating glazing unit that includes a shear-resistant spacer that is bonded in a shear-resistant manner to two outer panes with a high-tensile adhesive. The spacer has a groove in which the middle pane of the triple insulating glazing unit is fixed. The fixing is ensured, for example, by a butyl seal in the groove. The two interpane spaces are hermetically sealed from one another.

The spacers described in WO 2010/115456 A1 and in DE 10 2009 057 156 A1, which can accommodate a third pane in a groove, have the advantage that only a single spacer has to be installed and, thus, the step of the alignment of two individual spacers in the prior art triple glazing unit is eliminated. Both documents describe the fixing of the middle pane using a seal such that an exchange of air between the inner interpane spaces is prevented and the two interpane spaces are hermetically sealed from one another. This has the disadvantage that no pressure equalization between the individual interpane spaces can occur. With temperature differences between the interpane space turned toward the building interior and the interpane space turned toward the building exterior, pressure differences arise between the two interpane spaces. When the interpane spaces are hermetically sealed, no equalization can occur, as a result of which there is a high load on the middle pane. In order to increase the stability of the middle pane, thicker and/or prestressed panes must be used. This results in increased material and production costs.

From WO 2014/198429 A1 and WO 2014/198431, triple insulating glazing units and methods for producing triple insulating glazing units are known. According to the known for producing a triple insulating glazing unit, the inner or third pane is inserted into the groove of the spacer, then, the first pane is installed on the first pane contact surface and the second pane is installed on the second pane contact surface of the spacer, and, thereafter, the pane arrangement comprising the panes and the spacer is pressed together.

The spacer is preferably filled with a molecular sieve (mol sieve) or a molecular sieve mixture. This process step is performed by a filling device. With the known filling devices, the necessary molecular sieve filling for the insulating glazing cannot be checked during the filling operation. The filling devices have integrated through-flow measurement that is resistance sensitive. When the mass flow stops, the production system halts and incorrectly indicates that the spacer frame is filled. It is not possible, during production, to determine how high the fill level is and whether the desired amount of molecular sieve is in the spacer frame. The quantities of insufficiently filled spacer frames are still high.

Due to the varying frame sizes, gross malfunctions and differences of a few grams cannot be detected. Especially with older production systems, there is a high risk of filling errors.

Depending on the maintenance condition, production systems present a fluctuation range of 10% to 40% of improperly filled spacer frames. Due to the varying spacer frame sizes, gross malfunctions and differences of a few grams cannot be detected.

The molecular sieve filling is relevant to quality. To produce a spacer complying with standards, it is necessary to fill a specified amount of molecular sieve into the spacer frame.

DE 10 2008 028010 describes a method for filling a spacer with a desiccant. The filling of the spacer with a desiccant ends as soon as the fill level in a vertical leg of the spacer reaches a filling opening, which is determined by a resistance-sensitive bulk-material flow detector. The spacer is weighed before and after filling with the desiccant. The measured weight is compared to a target weight that is stored in advance or determined from measured parameters of the spacer. Parameters of the spacer stored in advance or measured are used exclusively for determining the target weight of the spacer. There is no determination of the period of time for filling the spacer.

One object of the present invention is to provide an economical and environmentally sound as well as reproducible method for filling a spacer frame for producing an insulating glazing unit.

Another object of the present invention is to provide a device for filling a spacer frame for producing an insulating glazing unit.

The object of the present invention is accomplished according to the invention by a method for filling a spacer frame for producing an insulating glazing unit according to the independent claim 1. Preferred embodiments of the invention are apparent from the subclaims.

The object of the present invention is, consequently, accomplished by a method for filling a spacer frame with a filler, in particular a molecular sieve or a molecular sieve mixture, for producing an insulating glazing unit with the following process steps, wherein at least
a) the fill time for filling the spacer frame (to a fill level of 100%) is calculated,
b) the spacer frame is inserted into a filling device with scales and a frame holder, wherein the spacer frame is suspended in suspension devices,
c) the spacer frame is filled for the calculated fill time, and
d) the spacer frame is weighed and the fill level is determined and if the fill level is >90%, the filling of the spacer frame is terminated.

The method according to the invention enables simple, reliable, and replicable control of the filling of spacer frames for the insulating glazing unit. The spacer frame can be weighed during and/or after filling with the filler.

The term “fill level” designates the relative amount of the filler contained in the spacer frame, with a fill level of 100% corresponding to a specifiable or specified target filling of the spacer frame with filler (in other words, target amount of filler based on a volume of the spacer frame for accommodating the filler). Values below 100% refer to a lower filling than the target filling. Values above 100% refer to a greater filling than the target filling.

A preferred embodiment of the invention is a method for filling a spacer frame, wherein the fill time of the spacer frame is calculated using the input frame size and frame width. Particularly good results are obtained therewith.

A preferred embodiment of the invention is a method for filling a spacer frame, wherein parameters of the spacer frame are input, at least the distance of the holes from the corner, the size of the corner connectors, the fill rate in grams per second as a function of the profile type and profile size of the spacer frame, the fill amount in grams per meter as a function of the profile type and profile size of the spacer frame, spacer frame size and spacer frame width. Particularly good at results are obtained therewith.

A preferred embodiment of the invention is a method for filling a spacer frame, wherein the empty spacer frame is weighed and the empty weight of the spacer frame is compared to the calculated empty weight. Particularly good at results are obtained therewith.

A preferred embodiment of the invention is a method for filling a spacer frame, wherein if the actual spacer frame empty weight matches the calculated empty weight, the filling operation is continued. Particularly good at results are obtained therewith.

A preferred embodiment of the invention is a method for filling a spacer frame, wherein if the fill level is 90% to 110%, the filling of the spacer frame is terminated.

A preferred embodiment of the invention is a method for filling a spacer frame, wherein if the fill level is >110%, the filling of the spacer frame is terminated and the new fill rate is calculated.

A preferred embodiment of the invention is a method for filling a spacer frame, wherein if the fill level is <90%, the remaining fill time is calculated and the spacer frame is topped up.

A preferred embodiment of the invention is a method for filling a spacer frame, wherein if the fill level is three times<90%, the filling operation is aborted. Particularly good results are obtained therewith, since the filling operation is only aborted with those spacer frames that are defective.

A preferred embodiment of the invention is a method for filling a spacer frame, wherein if the filling operation is aborted two times in succession, the new fill rate is calculated.

Particularly good results are obtained therewith, since, in this manner, a large number of the spacer frames not completely filled initially are filled.

The invention also extends to a device for filling a spacer frame with a filler for producing an insulating glazing unit, at least comprising:
a filling device with scales and a frame holder and suspension devices, which are designed such that the spacer frame can be suspended on the suspension devices,
the scales are designed such that they can move upward relative to the suspension devices and can weigh the empty spacer frame or the filled spacer frame,
the filling device is designed such that it conveys the filler and fills the spacer frame with the filler.

The device according to the invention is designed for carrying out the method according to the invention.

The double insulating glazing unit and the triple insulating glazing unit thus produced according to the invention are preferably used in construction and architecture indoors and outdoors.

The invention is explained in detail in the following with reference to drawings and examples. The drawings are purely schematic representations and are not true to scale. They in no way restrict the invention. They depict:

FIG. 1 a plan view of the device according to the invention with scales and a frame holder for filling the spacer frame,

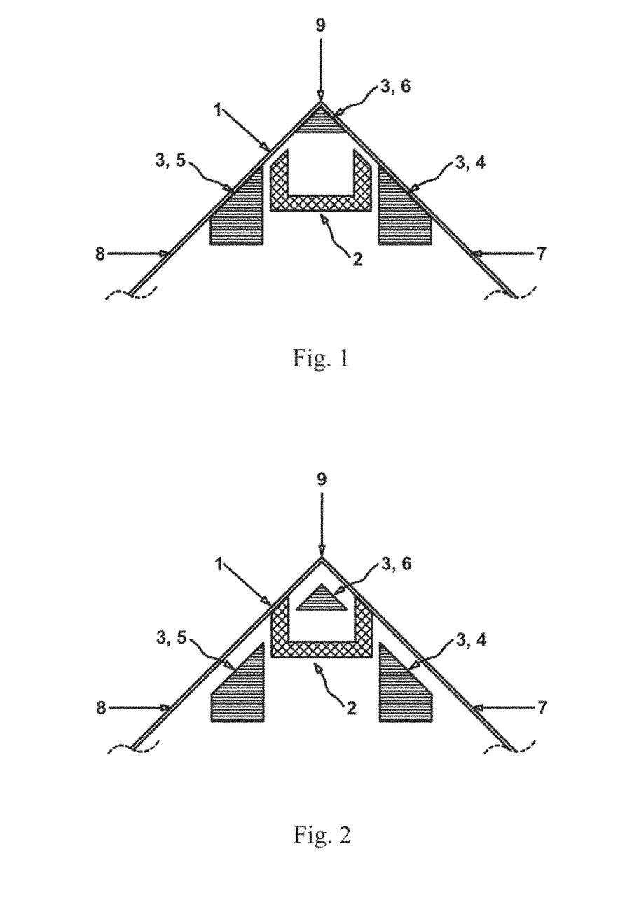

FIG. 2 a plan view of the device according to the invention with scales and a frame holder for filling the spacer frame,

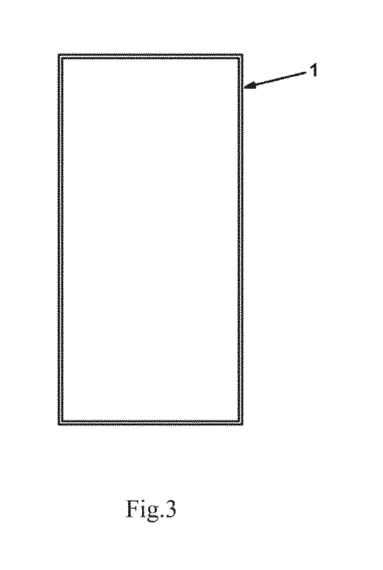

FIG. 3 a plan view of a spacer frame for an insulating glazing unit, and

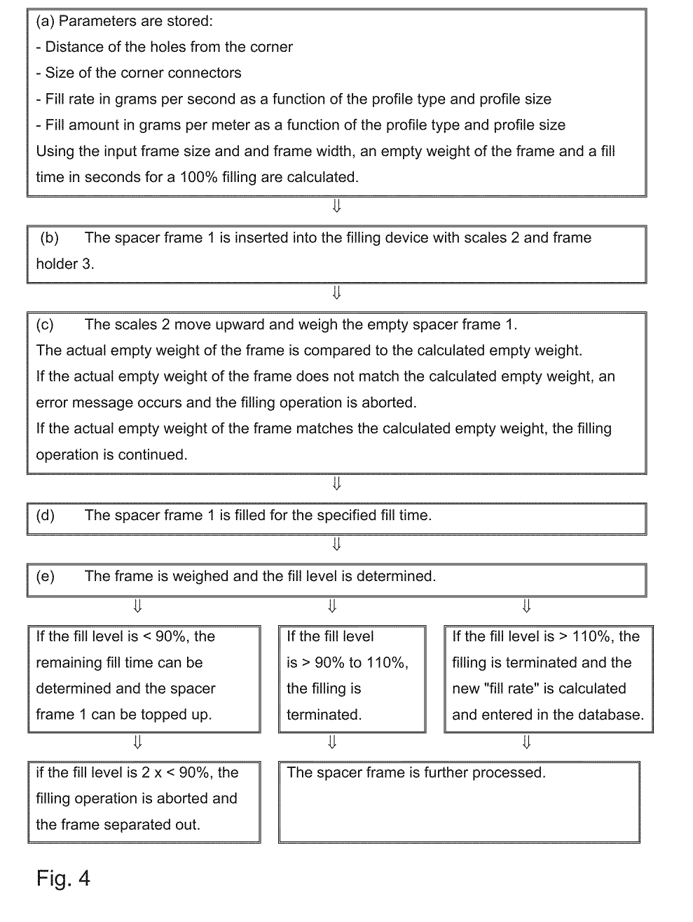

FIG. 4 a flowchart of a possible embodiment of the method according to the invention.

FIG. 1 and FIG. 2 depict a plan view of the device or filler mentioned with scales 2 and a frame holder 3 for filling the spacer frame 1. FIGS. 1 and 2 depict details of the spacer frame 1, namely, a corner 9. The spacer frame 1 is suspended in the device by one of the four corners 9. The frame holder 3 includes three suspension devices 4, 5, and 6, on which the spacer frame 1 is suspended. The suspension devices 4 and 5 serve for suspending the spacer frame 1 on two legs 7 and 8, respectively. The suspension device 6 serves for suspending the spacer frame 1 in the corner 9. The spacer frame 1 is suspended on the suspension devices 6, 7, and 8 for filling with molecular sieve.

The spacer frame 1 is inserted into the filling device with scales 2 and the frame holder 3. The scales 2 move upward relative to the suspension devices 4, 5, 6 and weigh the empty spacer frame 1. The fill time for a filling to 100% is calculated in seconds and the spacer frame 1 is filled for the specified fill time. If the fill level is <90%, the remaining fill time is determined and the spacer frame 1 is topped up. If the fill level is >90% to 110%, the filling is terminated. If the fill level is >110%, the filling is terminated and the new “fill rate” is calculated and entered in the database. If the fill level is <90%, the remaining fill time is determined and the spacer frame 1 is, optionally, topped up.

FIG. 3 depicts a plan view of a spacer frame 1. The spacer frame 1 is shaped to form a rectangle. A spacer frame 1 made of one straight part is bent at four corners and the free end pieces welded. The spacer frame 1 can also be assembled from four straight parts plugged together by so-called corner connectors. In cross-section, the spacer can be implemented such that it is suitable to hold two panes at a prescribed distance and to join them to form an insulating glazing unit from two panes. The spacer can be implemented such that it holds three panes at a prescribed distance and joins them to form an insulating glazing unit from three panes. The geometry of a spacer 1 for joining two panes for producing a double insulating glazing unit is known from WO 2013/104507 A1, among others. The geometry of a spacer 1 for joining three panes for producing a triple insulating glazing unit is known from WO 2014/198429 A1 and WO 2014/198431 A1, among others. The disclosures of WO 2013/104507 A1, WO 2014/198429 A1, and WO 2014/198431 A1 are incorporated in this patent application by reference.

FIG. 4 depicts a flowchart of a possible embodiment of the method according to the invention.

### EXAMPLE

100 spacers (frames) were filled in accordance with the method according to the invention. For this, the following parameters were stored in the software:

the distance of the holes from the corner,

the size of the corner connectors, fill rate in g/s as a function of the profile type and profile size,

the fill amount in g/m as a function of the profile type and profile size.

The fill time was calculated using the input frame size and frame width.

The frame was inserted into the filler (the filling device).

The scales were moved upward and the empty frame was weighed.

The fill time of filling to 100% (fill level) was calculated at 5 sec.

The frame was filled for 5 sec.

The scales were moved upward and the filled frame was weighed.

The fill level of the frame was determined.

The filling of 100 frames yielded the following result.

85 frames had a fill level between 90% and 100%. These frames could be further processed immediately.

5 frames had a fill level between 100% and 110%. These frames could be further processed immediately.

10 frames had a fill level of <90%. The remaining fill time was determined and the frames were topped up.

8 frames had a fill level between 90% and 100%. These frames could be further processed.

2 frames had a fill level of <90% auf. These frames were separated out.

The results are clearly presented in the following Table 1.

| Number | Fill level | Filling operation |
|---|---|---|
| 85 | 90% to 100% | 1 |
| 5 | 100% to 110% | 1 |
| 8 | 90% to 100% | 2 |
| 2 | <90% | 2 |

This means that 98% of the frames could be further processed.

### COMPARATIVE EXAMPLE

100 spacers (frames) were filled in accordance with the method according to the invention. The filling device (the filler) was outfitted with an integrated through-flow measurement. The 100 frames were weighed after filling. The through-flow measurement is resistance sensitive. If the mass flow stops, the system stops and indicates that the frame is filled.

The results are clearly presented in the following Table 2.

| Number | Fill level | Filling operation |
|---|---|---|
| 85 | 90% to 100% | 1 |
| 15 | <90% | 1 |

This means that 85% of the frames could be further processed.

The result was unexpected and surprising. With the method according to the invention, the number of frames that can be further processed was successfully increased from 85 to 98, and, thus, the yield was increased by 13%.

The significant advantage of the method according to the invention resides in the fact that defective frames are identified in a timely manner and separated out and do not make it into further processing.

### LIST OF REFERENCE CHARACTERS

1 spacer, spacer frame, frame
2 scales
3 frame holder
4 suspension devices
5 suspension devices
6 suspension devices
7 leg
8 leg
9 corner

1.-11. (canceled)

12. A method for filling a spacer frame with a filler for producing an insulating glazing unit, comprising:
a) calculating a fill time for filling the spacer frame to a fill level of 100%;
b) inserting the spacer frame into a filling device with scales and a frame holder, such that the spacer frame is suspended in suspension devices;
c) filling the spacer frame for the fill time calculated in step a);
d) weighing the spacer frame and determining the fill level; and
e) terminating filling of the spacer frame if the fill level is larger than 90%.

13. The method for filling a spacer frame according to claim 12, wherein the fill time of the spacer frame is calculated based on an input frame size and an input frame width.

14. The method for filling a spacer frame according to claim 12, further comprising:
providing a distance of holes from a corner of the spacer frame as input;
providing a fill rate as input and as a function of a profile type and a profile size of the spacer frame;
providing a fill amount as input and as a function of the profile type and the profile size of the spacer frame; and
providing as input, a spacer frame size and a spacer frame width.

15. The method for filling a spacer frame according to claim 12, further comprising:
weighing the spacer when empty to generate a measured empty spacer frame weight; and
comparing the measured empty spacer frame weight with a calculated empty weight.

16. The method for filling a spacer frame according to claim 12, further comprising, after the step of comparing the measured empty spacer frame weight with a calculated empty weight, continuing filling operation if the measured empty spacer frame weight matches the calculated empty weight.

17. The method for filling a spacer frame according to claim 12, further comprising terminating step c) if the fill level is from 90% to 110%.

18. The method for filling a spacer frame according to claim 12, further comprising terminating step c) and calculating a new fill rate if the fill level is larger than 110%.

19. The method for filling a spacer frame according to claim 12, further comprising determining a fill time and topping up the spacer frame if the fill level is smaller than 90%.

20. The method for filling a spacer frame according to claim 19, further comprising aborting step c) if three times the fill level is less than 90%.

21. A device for filling a spacer frame, comprising:
a filling device for conveying a filler to fill the spacer frame with the filler, including a frame holder and suspension devices for suspending a spacer frame, and upwardly movable scales for weighing the spacer frame.

22. A method of using an insulating glazing unit, comprising:
providing a spacer produced in accordance with the method according to claim 12; and
using the spacer in construction, in architecture indoors or in architecture outdoors.
